(19) United States
(12) Patent Application Publication
(10) Pub. No.: US 2009/0127235 A1
(43) Pub. Date: May 21, 2009

(54) Multi-beam laser bonding apparatus and bonding method using the same

(75) Inventors: LiDing Wei, Dongguan (CN); Jingshu Shi, Dongguan (CN)

Correspondence Address: NIXON & VANDERHYE, PC, 901 NORTH GLEBE ROAD, 11TH FLOOR, ARLINGTON, VA, 22203, US

(73) Assignee: SAE MAGNETICS (H.K.) LTD., N.T. SHATIN, HONG KONG (CN)

(21) Appl. No.: 12/222,390

(22) Filed: Aug. 7, 2008

(30) Foreign Application Priority Data
Nov. 21, 2007 (CN) 200710186886.3

(51) Int. Cl. B23K 26/00

(52) U.S. Cl. 219/121.63; 219/121.64

(57) ABSTRACT

A multi-beam laser bonding apparatus includes a laser beam irradiation unit for irradiating a unique laser beam and an optical instrument. The bonding apparatus is for bonding parts by a plurality of bonding media which are separated from each other at a predetermined distance. The optical instrument is positioned on a path of the unique laser beam for splitting the unique laser beam into a plurality of laser beams and focusing the plurality of laser beams onto the respective bonding media. The present invention also discloses a multi-beam laser bonding method with this bonding apparatus.

### FIELD OF THE INVENTION

The present invention relates to a bonding apparatus and method for micro joining, and more particularly to a bonding apparatus and method for bonding with multi-beam laser.

### BACKGROUND OF THE INVENTION

Applying laser beam technique in bonding process is a mean way in micro-joining field. With the laser technique, SBB (solder ball bonding) is a common bonding method in the manufacturing process of HDDs (hard disk drive) and so on. In SBB process, the high power industry laser has been widely used for its local heating capability.

There are two processes derived from SBB, one shot SBM (solder ball mounting) process and two shots SBM process. In one shot SBM process, a solder ball is deposited on a bonding pad by a nozzle which flows nitrogen gas, and then melted and formed by one shot laser. In two shots SBM process, deposited solder ball is pre-cured and fixed firstly by lower power laser on the bonding pad and then melted and formed by higher power laser.

FIG. 1 shows a conventional SBM process. It should be noted that FIG. 1 is for bonding a magnetic head slider (not shown) with a suspension of an HGA (head gimbal assembly) by SBM process. As shown in FIG. 1, Cu bonding pads 54 are embedded in the suspension 55. Several solder balls 53 are deposited on the bonding pads 54. The slider is located behind the solder balls 53 and cannot be seen in FIG. 1. A laser beam irradiation unit 50 which is located in a laser nozzle (not shown) moves following the disposition of the solder balls 53 along the arrowed direction X. A unique laser beam 52 which is released from the laser beam irradiation unit 50 and passes through the bottom of the laser nozzle irradiates on the solder balls 53 one by one.

In two shots SBM process, a low power laser is released from the laser beam irradiation unit 50 first for pre-bonding the solder balls 53 on the bonding pads 54 one by one. A surface layer of the solder ball 53 melts and the bottom surface of the solder ball 53 adheres to the corresponding bonding pad 54. After pre-bonding all the solder balls 53, the laser beam irradiation unit 50 moves back and releases a high power laser to melt the solder balls 53 completely one by one, then the melted solder spreads on the bonding pad 54 and forms joint under the effect of fluid surface tension. Without pre-bonding process, the laser nozzle with the laser beam irradiation unit 50 gets closer to the solder ball and melts it directly, which is called one shot SBM process.

It can be found that both methods of SBM have a common characteristic: melt the solder balls one by one. Therefore, the efficiency of production is very low.

In addition, for super high-density area packaging, the problem about inhomogeneous heating of the solder balls with traditional SBM process is increasingly serious with reduction of space between the solder balls. This affects the bonding quality and reliability.

Furthermore, under the limit of optic technique applied in the traditional SBM process, the unique laser beam released from the laser beam irradiation unit should be moved by a step motor following the disposition of the solder balls, and then cure the solder balls. When the slider size goes down and down, it's inconvenient to move and adjust the unique laser beam in very limit room. A possibly evocable offset will affect more. If the laser beam can not be focused on corresponding solder ball, plural type of failure will be brought.

As is well known, when object is heated, it deforms. This physical nature also works in the suspension. The suspension is composed of a metal flexure, a Cu trace layer, and a polyimide layer. During SBM process, the suspension receives heat conducted by the solder balls from the laser beam. This heat will cause the suspension deformation and the metal flexure will deform more evidently. In the traditional SBM process, the solder balls are melted sequentially, so the suspension is heated asymmetrically, and so the deformation is asymmetric. This kind of asymmetric deformation will cause an unexpected PSA (pitch/roll static angle) change which, in turn, will adversely affect the flying performance of the slider.

Hence, a need has arisen for providing an improved laser bonding apparatus and method to improve the production efficiency and the bonding stability.

### SUMMARY OF THE INVENTION

Accordingly, one objective of the present invention is to provide a multi-beam laser bonding apparatus for bonding parts by a plurality of bonding media, which is capable of irradiating the plurality of bonding media at the same time, thereby increasing the bonding efficiency and the stability of the bonding process.

Another objective of the present invention is to provide a multi-beam laser bonding method for bonding a part to a substrate, which is capable of melting a plurality of solder balls at the same time, thereby increasing the bonding efficiency and the stability of the soldering process.

Still another objective of the present invention is to provide a multi-beam laser bonding method for curing epoxy which adhere multi-groups of part and substrate, which is capable of curing epoxy adhesive between the parts and the respective substrates at the same time, thereby increasing the bonding efficiency and the stability of the bonding process.

To achieve the above-mentioned objectives, a multi-beam laser bonding apparatus of the present invention comprises a laser beam irradiation unit for irradiating a unique laser beam and an optical instrument. The bonding apparatus is for bonding parts by a plurality of bonding media which are separated from each other at a predetermined distance. The optical instrument is positioned on a path of the unique laser beam for splitting the unique laser beam into a plurality of laser beams and focusing the plurality of laser beams onto the respective bonding media.

In an embodiment of the bonding apparatus according to the present invention, the optical instrument comprises a diffractive optical element and a set of lens. The diffractive optical element is positioned between the laser beam irradiation unit and the set of lens.

Preferably, the diffractive optical element is a diffraction grating having a stepped surface or a plurality of parallel grooves with different depth.

In another embodiment of the bonding apparatus according to the present invention, the optical instrument, in order from the laser beam irradiation unit side, comprises a cylinder lens, a set of lens, and a pinhole board.

A multi-beam laser bonding method for bonding a part to a substrate comprises the steps of: (11) disposing a plurality of solder balls between the part and the substrate in such a manner that the solder balls are separated from each other at a predetermined distance; (12) providing a laser beam irradiation unit for irradiating a unique laser beam; (13) providing an optical instrument and positioning the optical instrument on a path of the unique laser beam for splitting the unique laser beam into a plurality of laser beams and focusing the plurality of laser beams onto the respective solder balls; and (14) irradiating the solder balls with the plurality of laser beams simultaneity to melt the solder balls and therefore to solder the part to the substrate.

In an embodiment of the bonding method of the present invention, the step (14) comprises firstly irradiating the solder balls with low power laser beams to melt the surface layer of the solder balls so as to fix the solder balls on the substrate and then irradiating the solder balls with high power laser beams to melt the solder balls completely.

A multi-beam laser bonding method for curing epoxy which adhere multi-groups of part and substrate comprises the steps of: (21) applying epoxy adhesive between the parts and the respective substrates; (22) separating the multi-groups of part and substrate from each other at a predetermined distance; (23) providing a laser beam irradiation unit for irradiating a unique laser beam; (24) providing an optical instrument and positioning the optical instrument on a path of the unique laser beam for splitting the unique laser beam into a plurality of laser beams and focusing the plurality of laser beams onto the respective groups of part and substrate; and (25) irradiating the epoxy adhesive with the plurality of laser beams simultaneity to cure the epoxy adhesive and therefore the multi-groups of part and substrate are bonded at the same time.

In comparison with the traditional bonding process, in which solder balls are melted and formed sequentially, in the present bonding process, the plurality of bonding media can be melted and formed simultaneously because the unique laser beam is split by the optical instrument into a plurality of laser beams and the laser beams are focused onto the respective bonding media at the same time, thus the bonding efficiency is increased dramatically. Moreover, the laser beam irradiation unit need not to be moved, so the error caused by the move means can be avoided, thus the stability of the bonding process and the quality of the bond can be improved. Further, the heating time is reduced, so the deformation of the heated object can be minimized.

### BRIEF DESCRIPTION OF THE DRAWINGS

FIG. 1 is a schematic view showing a conventional SBM process;

FIG. 2 is a schematic view showing a SBM process using a multi-beam laser bonding apparatus according to an embodiment of the present invention, taken an HGA as an example;

FIG. 3 is a side view of FIG. 2;

FIG. 4a is a schematic view of an optical instrument for the multi-beam laser bonding apparatus according to an embodiment of the present invention;

FIG. 4b shows a diffraction grating of the optical instrument shown in FIG. 4a;

FIG. 5 shows an image diagram of the multi-beam laser passing through the optical instrument shown in FIG. 4a;

FIGS. 6a-6h illustrate a fabrication process of the diffraction grating shown in FIG. 4b;

FIG. 7a is a schematic view of an optical instrument for the multi-beam laser bonding apparatus according to another embodiment of the present invention;

FIG. 7b shows an image diagram of the multi-beam laser passing through the optical instrument shown in FIG. 7a;

FIG. 8 is a flow chart showing steps of a multi-beam laser bonding method for bonding a part to a substrate according to an embodiment of the present invention;

FIG. 9 is a schematic view which shows a bonding process using the multi-beam laser bonding apparatus according to another embodiment of the present invention, taken five HGAs as an example; and

FIG. 10 is a flow chart showing steps of a multi-beam laser bonding method for bonding multi-groups of part and substrate according to another embodiment of the present invention.

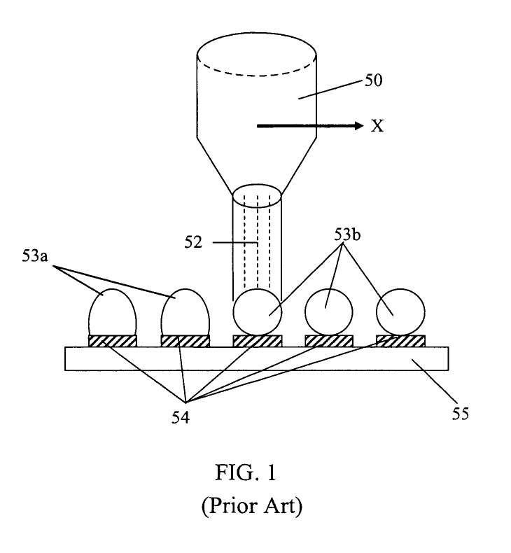

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a multi-beam laser bonding apparatus which is capable of irradiating several bonding media at the same time and, in turn, increasing the bonding efficiency and avoiding problems caused by single laser beam, thereby increasing the production capacity and achieving a steady bonding quality.

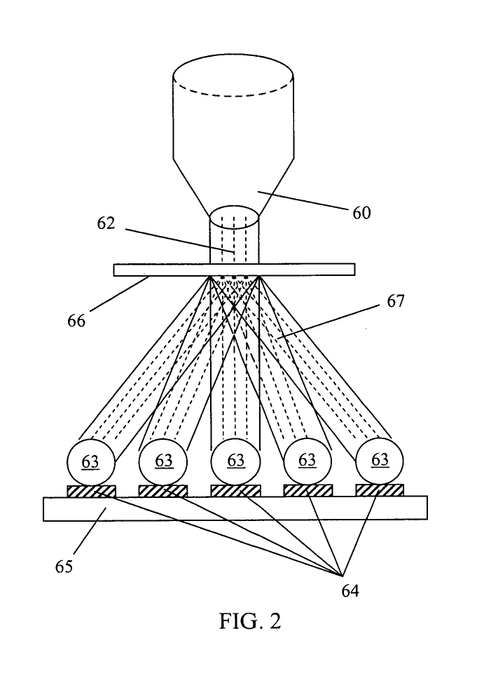

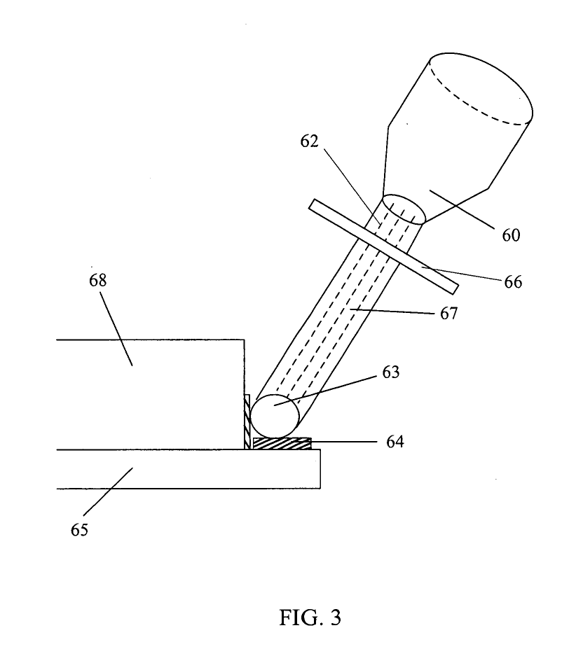

FIG. 2 is an explanatory schematic diagram that shows a SBM process using the multi-beam laser bonding apparatus according to an embodiment of the present invention. Referring to FIG. 2-3, taken an HGA as an example, a suspension 65 of the HGA has normally several layers (not shown in the figure), one of which is Cu trace layer. The Cu trace layer is pasted on the suspension 65 and forms a plurality of such as five bonding pads 64. A slider 68 is disposed on the suspension 65. A plurality of such as five solder balls 63 is positioned between the bonding pads of the slider 68 and the suspension 65 to bond the slider 68 and the suspension 65.

The multi-beam laser bonding apparatus of the present invention includes a laser beam irradiation unit 60 and an optical instrument 66, both of which are positioned in a laser nozzle (not shown in the figure). As shown in 60 as in traditional SBM process. The optical instrument 66 is positioned on the path of the unique laser beam 62. The unique laser beam 62 passes through the optical instrument 66 and is spilt by the optical instrument 66 into a plurality of such as five laser beams 67, which is called multi-beam laser. The five laser beams 67 passing through the bottom of the laser nozzle are focused on the five solder balls respectively and irradiate the solder balls 63 to melt them at the same time. That is to say, only one action makes all the solder balls 63 melt, which can save time for the bonding process.

Since the solder balls are heated by the laser beams at one time, so the deformation of the suspension caused by heating can be minimized, and accordingly, the PSA change is reduced, finally resulting in an invariable flying height of the slider.

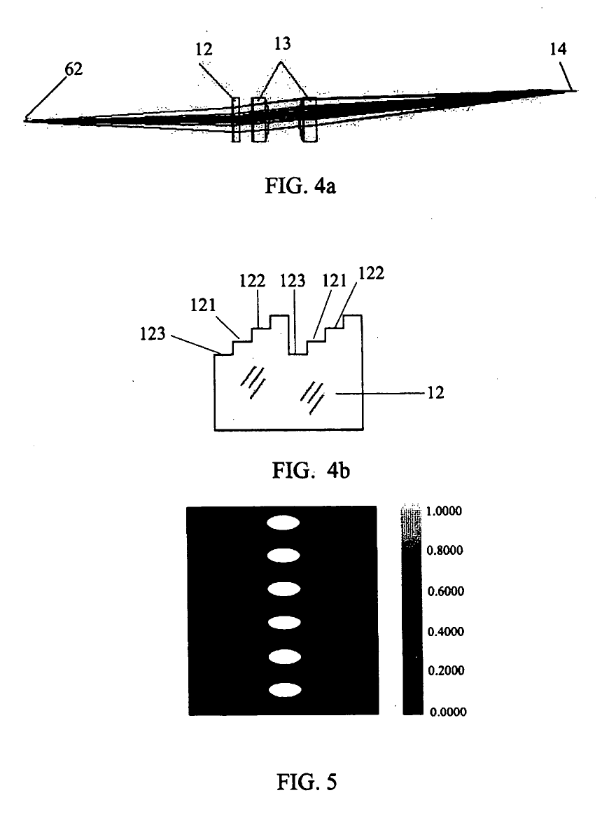

FIG. 4a shows an optical instrument for the multi-beam laser bonding apparatus of the present invention. As shown in FIG. 4a, the optical instrument 66 includes a diffractive optical element such as a diffraction grating 12 and a set of lens 13. The diffraction grating 12 is positioned between the unique laser beam 62 and the set of lens 13. At image location 14, we can see several spots with equal small intervals as shown in FIG. 5a. This testifies that the unique laser beam 62 is split into several laser beams by the diffraction grating 12 and then focused onto several points by the set of lens 13. As illustrated above, the solder balls 63 are namely located on the points and so can be heated at one time.

In general, a diffraction grating is a diffraction screen with periodical special configuration or optical characteristic (transmission index, refraction index etc.). FIG. 4b shows a diffraction grating having a stepped surface. Particularly, the stepped surface has three sets of parallel grooves with three different depths.

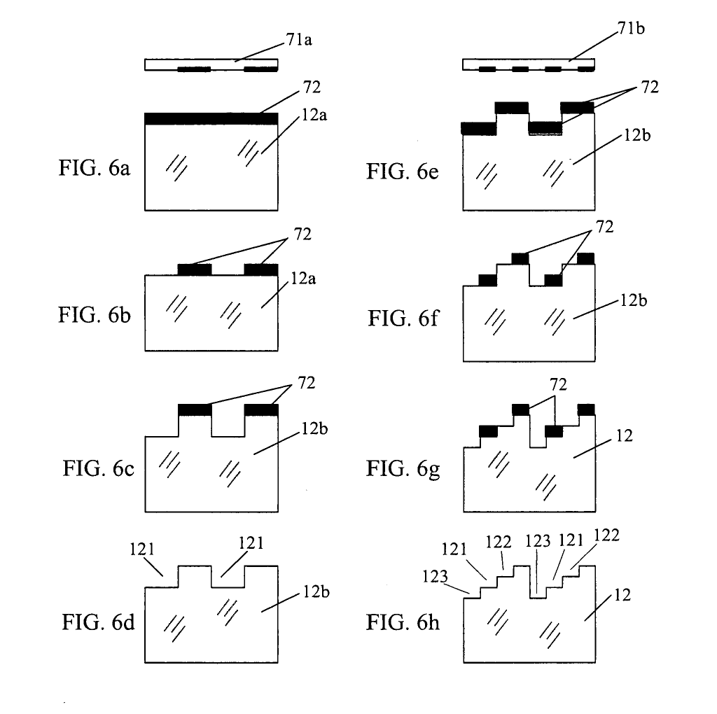

Referring to FIG. 4b and FIGS. 6a-6h, the fabricating process of the diffraction grating includes: a) printing photoresist 72 on a substrate 12a and providing a mask 71a to cover the photoresist 72; b) illuminating the photoresist 72 through the mask 71a to form a predetermined photoresist pattern on the substrate 12a; c) etching the substrate 12a to form the substrate 12b with two first depth grooves 121; d) removing the photoresist 72; e) printing photoresist 72 on the substrate 12b and providing another mask 71b to cover the substrate 12b; f) illuminating the photoresist 72 through the mask 71b to form another predetermined photoresist pattern on the substrate 12b; g) etching the substrate 12b to form the diffraction grating 12 with the second depth grooves 122 and the third depth grooves 123; h) removing the photoresist 72. The configuration of the diffraction grating can split a single laser beam into multi-beams.

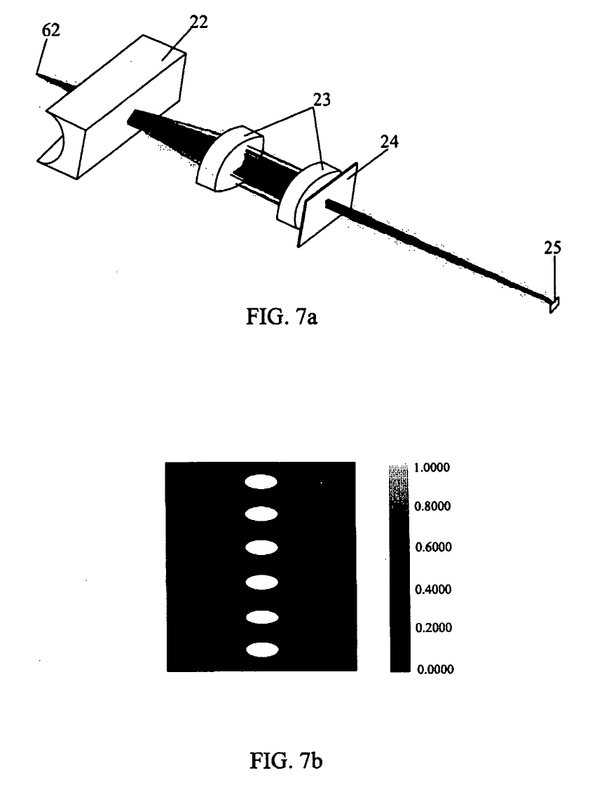

FIGS. 7a-7b illustrate another configuration of the optical instrument according to another embodiment of the present invention. In order from the laser beam irradiation unit 60 side, the optical instrument 66 includes a cylinder lens 22, a set of lens 23, and a pinhole board 24 with several elliptic apertures. Referring to FIG. 7a, the unique laser beam 62 passes through the cylinder lens 22 to be compressed. The spot of the laser beam 62 is deformed from round shape to a long and narrow shape. The set of lens 23 is positioned adjacent to the cylinder lens 22 to focus the laser beam. The pinhole board 24 is placed after the set of lens 23 to filter the laser beam. At image location 25, we can see several spots with equal small intervals, as shown in FIG. 6b. This also testifies that the unique laser beam 62 is split into multi-beams and focused onto several points. The solder balls 63 are namely located on the points and so can be heated at one time.

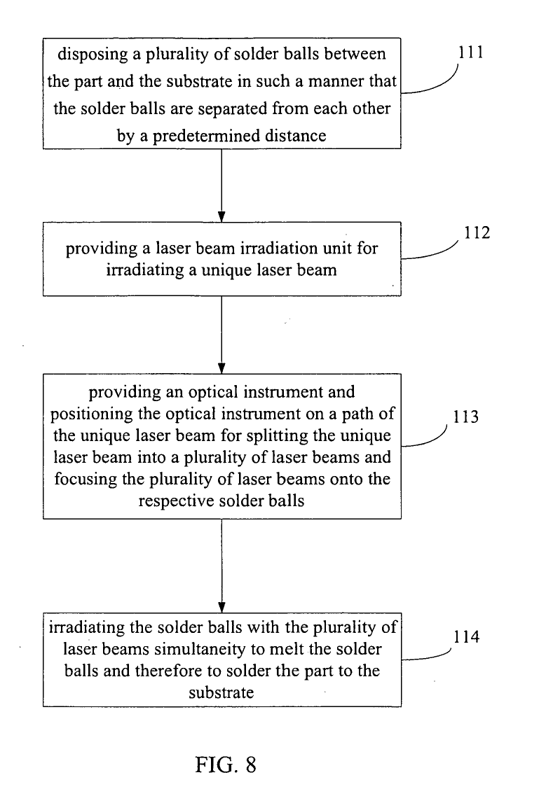

Referring to FIG. 8, the multi-beam laser bonding method for bonding a part to a substrate, which is used in the SBM process, includes the steps of:

(111) disposing a plurality of solder balls between the part and the substrate in such a manner that the solder balls are separated from each other at a predetermined distance;

(112) providing a laser beam irradiation unit for irradiating a unique laser beam;

(113) providing an optical instrument and positioning the optical instrument on a path of the unique laser beam for splitting the unique laser beam into a plurality of laser beams and focusing the plurality of laser beams onto the respective solder balls;

(114) irradiating the solder balls with the plurality of laser beams simultaneity to melt the solder balls and therefore to solder the part to the substrate.

The method described above is one shot SBM process, and the laser beams are high power laser. If using two shots SBM process, the step (114) includes firstly irradiating the solder balls with low power laser beams to melt the surface layer of the solder balls so as to fix the solder balls on the substrate and then irradiating the solder balls with high power laser beams to melt the solder balls completely.

The quantity of beams and the power of the laser beam can be changed to meet the actual needs by adjust the laser beam irradiation unit and the optical instrument. Without moving the laser beam, the quality of the bond and the stability of bonding process can be improved.

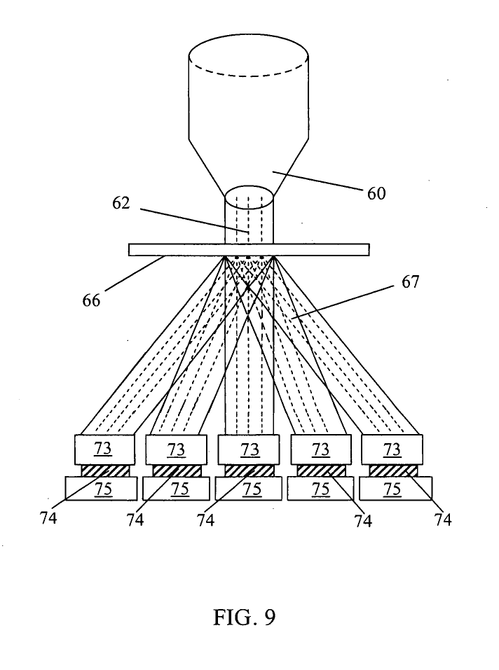

The multi-beam laser can be used in any bonding process, not limited in SBM process. As shown FIG. 9, sliders 73 are to be bonded to corresponding suspensions 75 by epoxy adhesive. We have the epoxy curing process by multi-beam laser. The principle of the epoxy curing process is similar to that of the SBM process.

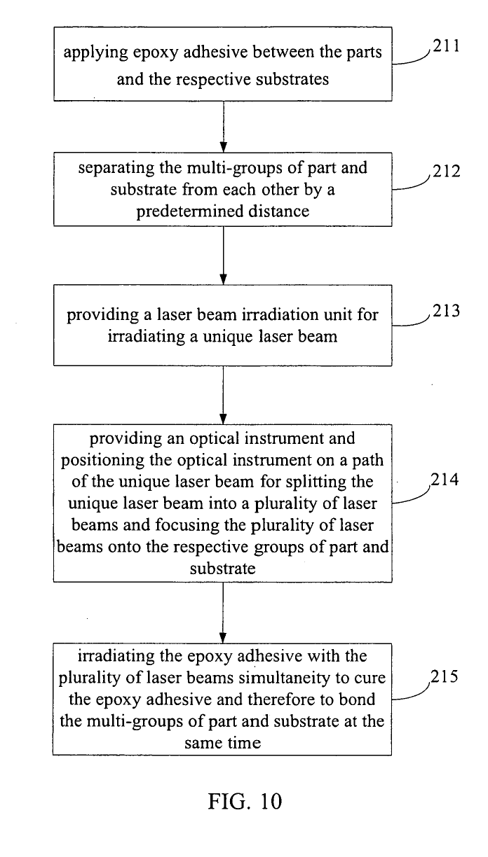

As shown in FIG. 10, the multi-beam laser bonding method for curing epoxy which adhere multi-groups of part and substrate, such as slider and suspension, includes the steps of:

(211) applying epoxy adhesive between the parts and the respective substrates;

(212) separating the multi-groups of part and substrate from each other at a predetermined distance;

(213) providing a laser beam irradiation unit for irradiating a unique laser beam;

(214) providing an optical instrument and positioning the optical instrument on a path of the unique laser beam for splitting the unique laser beam into a plurality of laser beams and focusing the plurality of laser beams onto the respective groups of part and substrate;

(215) irradiating the epoxy adhesive with the plurality of laser beams simultaneity to cure the epoxy adhesive and therefore the multi-groups of part and substrate are bonded at the same time.

It should be noted that this invention is not limited to solder balls and epoxy adhesive, other bonding media can also be used as long as it can be processed by laser beam.

The foregoing description of the present invention has been presented for purposes of illustration and description. It is not intended to be exhaustive or limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A multi-beam laser bonding apparatus for bonding parts by a plurality of bonding media which are separated from each other at a predetermined distance, the apparatus comprising:
a laser beam irradiation unit for irradiating a unique laser beam; and
an optical instrument positioned on a path of the unique laser beam for splitting the unique laser beam into a plurality of laser beams and focusing the plurality of laser beams onto the respective bonding media.

2. The multi-beam laser bonding apparatus as claimed in claim 1, wherein the optical instrument comprises a diffractive optical element and a set of lens, the diffractive optical element is positioned between the laser beam irradiation unit and the set of lens.

3. The multi-beam laser bonding apparatus as claimed in claim 2, wherein the diffractive optical element is a diffraction grating having a stepped surface.

4. The multi-beam laser bonding apparatus as claimed in claim 2, wherein the diffractive optical element is a diffraction grating having a plurality of parallel grooves with different depth.

5. The multi-beam laser bonding apparatus as claimed in claim 1, wherein the optical instrument, in order from the laser beam irradiation unit side, comprises a cylinder lens, a set of lens, and a pinhole board.

6. A multi-beam laser bonding method for bonding a part to a substrate comprising the steps of:
(1) disposing a plurality of solder balls between the part and the substrate in such a manner that the solder balls are separated from each other at a predetermined distance;
(2) providing a laser beam irradiation unit for irradiating a unique laser beam;
(3) providing an optical instrument and positioning the optical instrument on a path of the unique laser beam for splitting the unique laser beam into a plurality of laser beams and focusing the plurality of laser beams onto the respective solder balls; and
(4) irradiating the solder balls with the plurality of laser beams simultaneity to melt the solder balls and therefore to solder the part to the substrate.

7. The bonding method as claimed in claim 6, wherein the step (4) comprises firstly irradiating the solder balls with low power laser beams to melt the surface layer of the solder balls so as to fix the solder balls on the substrate and then irradiating the solder balls with high power laser beams to melt the solder balls completely.

8. The bonding method as claimed in claim 6, wherein the optical instrument comprises a diffractive optical element and a set of lens, the diffractive optical element is positioned between the laser beam irradiation unit and the set of lens.

9. The bonding method as claimed in claim 8, wherein the diffractive optical element is a diffraction grating having a stepped surface.

10. The bonding method as claimed in claim 8, wherein the diffractive optical element is a diffraction grating having a plurality of parallel grooves with different depth.

11. The bonding method as claimed in claim 6, wherein the optical instrument, in order from the laser beam irradiation unit side, comprises a cylinder lens, a set of lens, and a pinhole board.

12. A multi-beam laser bonding method for curing epoxy which adhere multi-groups of part and substrate comprising the steps of:
(1) applying epoxy adhesive between the parts and the respective substrates;
(2) separating the multi-groups of part and substrate from each other at a predetermined distance;
(3) providing a laser beam irradiation unit for irradiating a unique laser beam;
(4) providing an optical instrument and positioning the optical instrument on a path of the unique laser beam for splitting the unique laser beam into a plurality of laser beams and focusing the plurality of laser beams onto the respective groups of part and substrate; and
(5) irradiating the epoxy adhesive with the plurality of laser beams simultaneity to cure the epoxy adhesive and therefore the multi-groups of part and substrate are bonded at the same time.

13. The bonding method as claimed in claim 12, wherein the optical instrument comprises a diffractive optical element and a set of lens, the diffraction grating is positioned between the laser beam irradiation unit and the set of lens.

14. The bonding method as claimed in claim 13, wherein the diffractive optical element is a diffraction grating has a stepped surface.

15. The bonding method as claimed in claim 13, wherein the diffractive optical element is a diffraction grating having a plurality of parallel grooves with different depth.

16. The bonding method as claimed in claim 12, wherein the optical instrument, in order from the laser beam irradiation unit side, comprises a cylinder lens, a set of lens, and a pinhole board.
